(19) United States
(12) Patent Application Publication
(10) Pub. No.: US 2008/0242316 A1
(43) Pub. Date: Oct. 2, 2008

(54) MOBILE COMMUNICATION SYSTEM AND METHOD FOR MEASURING DISTANCE BETWEEN MOBILE PHONES

(75) Inventors: WEN-WU WANG, Shenzhen (CN); SHIH-FANG WONG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) Co., LTD ., Shenzhen City (CN); HON HAI PRECISION INDUSTRY CO., LTD., Tu-Cheng (TW)

(21) Appl. No.: 11/834,021

(22) Filed: Aug. 6, 2007

(30) Foreign Application Priority Data
Mar. 30, 2007 (CN) 200710200366.3

(51) Int. Cl. H04Q 7/20

(52) U.S. Cl. 455/456.2

(57) ABSTRACT

A mobile communication system includes at least one base transceiver station and a mobile switching center. The at least one base transceiver station is used for exchanging data with mobile phones. The mobile switching center is used for choosing one base transceiver station as a primary base transceiver station, and calculating positions of a first mobile phone and a second mobile phone. The position of the mobile phones include distances that the mobile phones are away from the primary base transceiver station, and an angle between the mobile phones relative to the primary base transceiver station. The mobile switching center is further used for calculating a distance between the first and second mobile phone according to the positions of the mobile phones. A related mobile communication method is also disclosed.

### BACKGROUND

1. Field of the Invention

The present invention generally relates to a system and method for measuring distances. Particularly, the present invention relates to a mobile communication system and method for measuring distance between mobile phones.

2. Description of Related Art

Mobile phones communicate with each other through base transceiver stations (BTSs). Usually, the BTSs are arranged to define a plurality of cells. Referring to FIG. 7, a mobile communication system 100 includes a plurality of BTSs 102. The BTSs 102 define a plurality of cells 104.

The BTSs 102 provide mobile communication services for mobile phones 106 that are located in corresponding cells 104. The mobile phones 106 exchange data with each other through the BTSs 102, thus mobile communications can be fulfilled. When a mobile phone 106 moves from one cell to the next, the BTSs 102 provide the transitional mobile communication services for the mobile phone 106.

A position of the mobile phone can be calculated according to positions of the BTSs. Referring to FIG. 8, in a mobile communication system 200, when a user wants to position a mobile phone 210, a positioning command is sent out from the mobile phone 210 (named a sender). The positioning command is transmitted to nearby BTSs 202, 204, 206. The BTSs 202, 204, and 206 are connected with a base station controller (BSC). Then, the positioning command is further forwarded to a mobile switching center (MSC) through the BSC. The MSC calculates distances between the sender 210 and each of the BTSs 202, 204, and 206, according to different arrival time of the positioning command from the sender 210 to each of the transceiver stations 202, 204 and 206. Since the positions of the BTSs are predetermined, the position of the sender 210 can be determined according to the distances calculated above.

However, users usually want to know the distance that he or she is away from a subscriber, besides acquiring his or her own position. Therefore, a mobile communication system and method for measuring the distance between mobile phones are needed.

### SUMMARY

A mobile communication system includes at least one base transceiver station and a mobile switching center. The at least one base transceiver station is used for exchanging data with mobile phones. The mobile switching center is used for choosing one base transceiver station as a primary base transceiver station, and calculating positions of a first mobile phone and a second mobile phone. The position of the mobile phones include distances that the mobile phones are away from the primary base transceiver station, and an angle between the mobile phones relative to the primary base transceiver station. The mobile switching center is further used for calculating a distance between the first and second mobile phone according to the positions of the mobile phones.

A mobile communication method includes steps of: choosing a base transceiver station as a primary base transceiver station; calculating a first position of a first mobile phone; calculating a second position of a second mobile phone; and calculating a distance between the first and the second mobile phone according to the first position of the first mobile phone and the second position of the second mobile phone.

Other systems, methods, features, and advantages of the present mobile communication system and method will be or become apparent to one with skill in the art upon examination of the following drawings and detailed description. It is intended that all such additional systems, methods, features, and advantages be included within this description, be within the scope of the present system and method, and be protected by the accompanying claims.

### BRIEF DESCRIPTION OF THE DRAWINGS

Many aspects of the present system and method can be better understood with reference to the following drawings. The components in the drawings are not necessarily to scale, emphasis instead being placed upon clearly illustrating the principles of the inventive system and method. Moreover, in the drawings, like reference numerals designate corresponding parts throughout the several views.

FIG. 1 is a schematic diagram of the mobile communication system according to an exemplary embodiment.

FIG. 2 is a schematic diagram of the mobile communication system according to another exemplary embodiment.

FIG. 3 is a schematic diagram of the mobile communication system according to another exemplary embodiment.

FIG. 4 is a workflow of the mobile communication system according to an exemplary embodiment.

FIG. 5 is a block diagram of the mobile switching center and the workflow of the calculation according to an exemplary embodiment.

FIG. 6 is a workflow of the calculation for the distance between the sender and the subscriber according to an exemplary embodiment.

FIG. 7 is a schematic diagram of a mobile communication system.

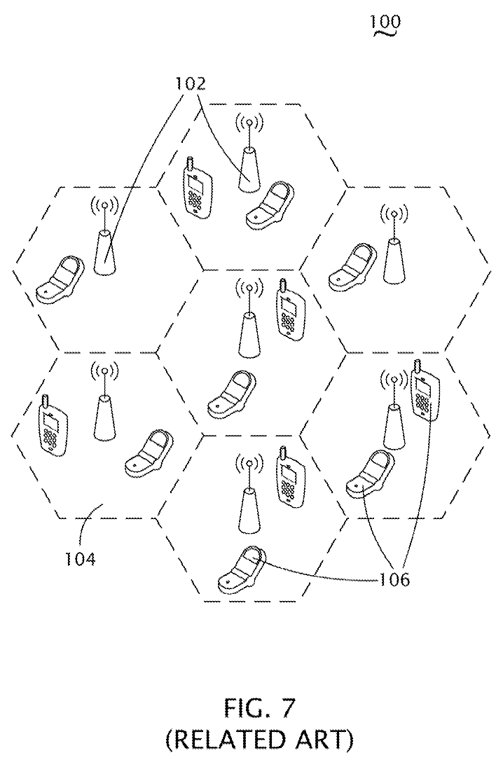

FIG. 8 is a schematic diagram of another mobile communication system.

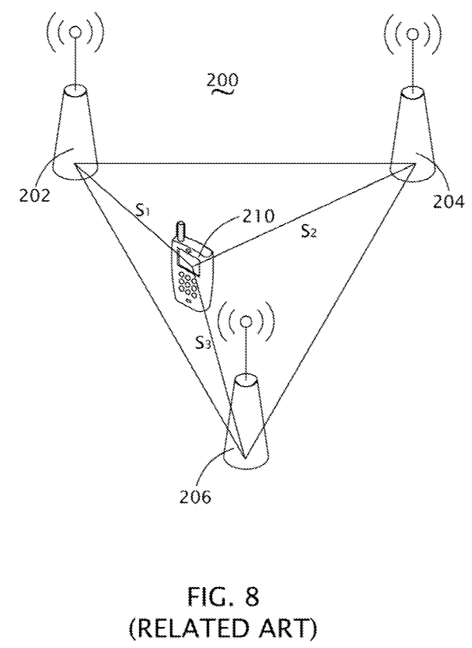

### DETAILED DESCRIPTION OF THE INVENTION

Reference will now be made to the drawings to describe exemplary and preferred embodiments of the present communication system and method.

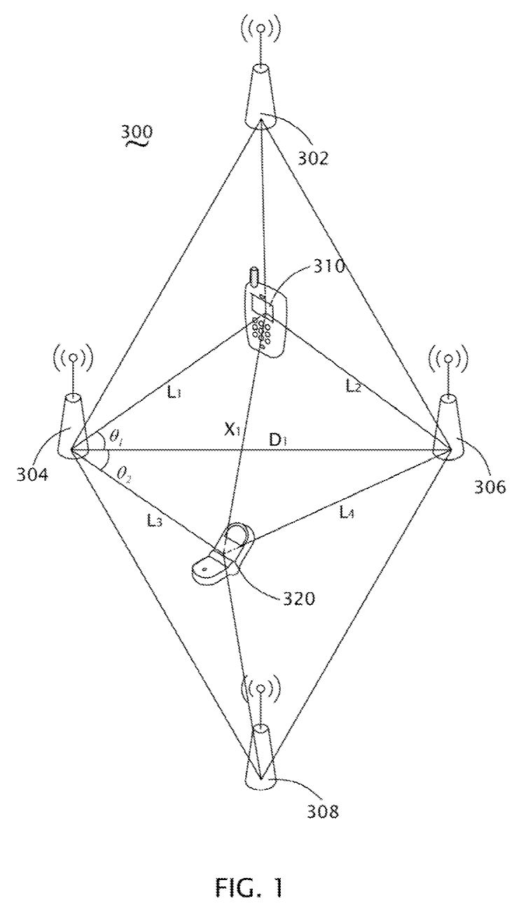

Referring to FIG. 1, a mobile communication system 300 includes a plurality of base transceiver stations (BTSs) 302, 304, 306, 308. Mobile phones 310, 320 exchange data with each other via either of or a combination of the BTSs 302, 304, 306, 308, thus performing data communications. The BTSs 302, 304, 306, 308 define a plurality of cell systems, and the BTSs 304, 306 cooperatively provide mobile communication services for the mobile phones 310, 320 (hereinafter the BTSs that shared by at least two cell systems are named as “shared BTSs”).

The mobile phones are configured to send out get distance requests. When one of the mobile phones, such as the mobile phone 310 (hereinafter referred as sender 310), broadcasts the get distance request to measure a distance between the sender 310 and the mobile phone 320 (hereinafter referred as subscriber 320). The BTSs 302, 304, 306 of the cell system where the sender 310 locates receive the get distance request, and forward the get distance request to a mobile switching center (MSC, not shown) connecting the BTSs.

When the MSC receives the get distance request, the MSC would calculate/compute a position of the sender 310 in a first cell system in relation to the BTS 302, 304, 306. In the preferred embodiment this can be achieved by triangulation using predetermined distances between the BTSs. The MSC would also calculate a position of the subscriber 320 in a second cell system in relation to BTS 304, 306, 308 by triangulation using predetermined distances between the BTSs. After the position of the sender 310 located in the first cell system and the position of the subscriber 320 located in the second cell system is calculated, a distance between the sender 310 and the subscriber 320 can also be calculated through triangulation using shared BTSs of the first cell system and the second cell system.

The MSC chooses one of the shared BTSs, such as the BTS 304, as a primary BTS, and chooses another BTS, such as the BTS 306, as a reference BTS. The MSC calculates the position of the sender 310, including a distance L₁ between the sender 310 and the primary BTS 304, and a distance L₂ between the sender 310 and the reference BTS 306.

In response to the measurement request, the MSC further calculates a position of the subscriber 320, including a distance L₃ between the subscriber 320 and the primary BTS 304, and a distance L₄ between the subscriber 320 and the reference BTS 306.

A distance D₁ between the primary BTS 304 and the reference BTS 306 is predetermined. Therefore, an angle θ₁ between the sender 310 and the reference BTS 306 relative to the primary BTS 304 can be calculated according to the Law of Cosines, by:

$${θ}_{1} = arccos ( \frac{{L}_{1}^{2} + {D}_{1}^{2} - {L}_{2}^{2}}{2 {L}_{1} {D}_{1}} ) .$$

Similarly, an angle θ₂ between the subscriber 320 and the reference BTS 306 relative to the primary BTS 304 can be calculated according to the Law of Cosines, by:

$${θ}_{2} = arccos ( \frac{{L}_{3}^{2} + {D}_{1}^{2} - {L}_{4}^{2}}{2 {L}_{3} {D}_{1}} ) .$$

An angle between the sender 310 and the subscriber 320 relative to the primary BTS 304 is θ₁+θ₂, thus the distance X₁ between the sender 310 and the subscriber 320 can also be calculated according to the Law of Cosines:

X₁=\sqrt{L₁²+L₃²−2L₁L₃ cos(θ₁+θ₂)}.

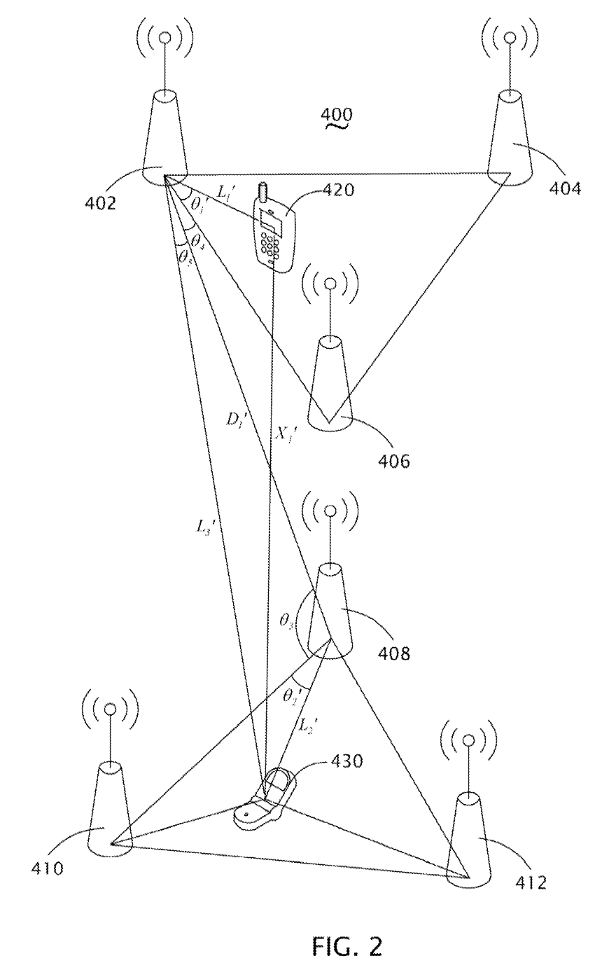

Referring to FIG. 2, a mobile communication system 400 according to another exemplary embodiment includes a plurality of BTSs 402, 404, 406, 408, 410, 412. A mobile phone 420 is located in a first cell system defined by the BTSs 402, 404, 406, and another mobile phone 430 is located in another cell system defined by the BTSs 408, 410, 412. The cell systems are not adjacent to each other, thus, the cell systems do not have shared BTS.

When one of the mobile phones, such as the mobile phone 420 (hereinafter refers as sender 420), sends out a get distance request for measuring the distance between the sender 420 and the mobile phone 430 (hereinafter refers as subscriber 430). The BTSs 402, 404, 406 that surround the sender 420 receive the get distance request, and forward the get distance request to a mobile switching center (MSC) connecting therewith.

The MSC chooses a first BTS of the cell system of the sender 420, such as the BTS 402, as a primary BTS; chooses a second BTS of the cell system of the sender 420, such as the BTS 406, as a first reference BTS; and chooses a third BTS of the cell system of the subscriber 430, such as the BTS 408, as a second reference BTS.

The BTSs 402, 404, and 406 surrounding the sender 420 can be used for positioning the sender 420. A distance L₁′ that the sender 420 is away from the primary BTS 402, and an angle θ₁′ between the sender 420 and the first reference BTS 406 relative to the primary BTs 402, can be calculated by the MSC connected with the BTSs 402, 404, and 406. Similarly, the BTSs 408, 410, and 412 surrounding the subscriber 430 can be used for positioning the subscriber 430. A distance L₂′ that the subscriber 430 is away from the second reference BTS 408, and an angel θ₂′ between the subscriber 430 and the BTS 410 relative to the second reference BTS 408, can be calculated by the MSC connected with the BTSs 408, 410, and 412.

A distance D₁′ between the primary BTS 402 and the second reference BTS 408, an angle θ₃ between the primary BTS 402 and the BTS 410 relative to the second reference BTS 408, an angle θ₄ between the first reference BTS 406 and the second reference BTS 408 relative to the primary BTs 402, is predetermined. Therefore, a distance L₃′ between the subscriber 430 and the primary BTS 402 can be calculated, by:

L₃′=\sqrt{D₁′²+L₂′²−2D₁′L₂′ cos(θ₂′+θ₃)};

and an angle θ₅ between the subscriber 430 and the second reference BTS 408 relative to the primary BTS 402 can also be calculated, by:

$${θ}_{5} = arccos ( \frac{{L}_{3}^{′2} + {D}_{1}^{′2} - {L}_{2}^{′2}}{2 {L}_{3}^{′} {D}_{1}^{′}} ) .$$

Accordingly, the distance X₁′ between the sender 420 and the subscriber 430 can be calculated according to the Law of Cosines:

X₁′=\sqrt{L₁′²+L₃′²−2L₁′L₃′ cos(θ₁′+θ₄+θ₅)}.

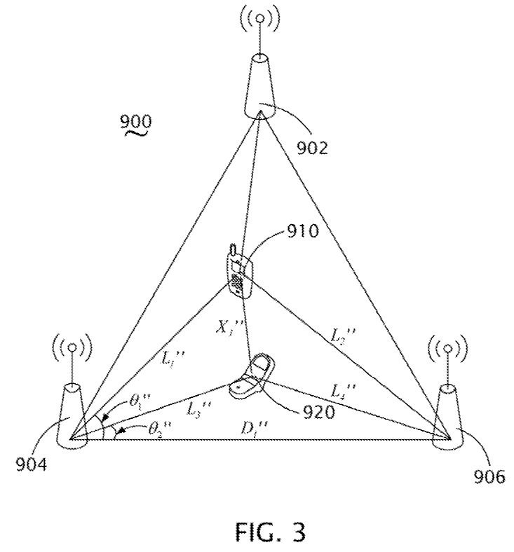

Referring to FIG. 3, in a mobile communication system 900 according to another exemplary embodiment, two mobile phones 910 and 920 are located in a common cell system defined by three BTSs 902, 904, 906. Therefore, the BTSs 902, 904, 906 are all shared BTSs serving for the mobile phones 910 and 920.

When one of the mobile phones, such as the mobile phone 910 (hereinafter refers as sender 910), sends out a get distance request for measuring a distance between the sender 910 and the mobile phone 920 (hereinafter refers as subscriber 920), one of the BTSs, the BTS 904 is chosen to be the primary BTS, another BTS 906 is chosen to be the reference BTS.

Similarly, the distance X₁″ between the sender 910 and the subscriber 920 can be calculated according to the Law of Cosines:

X₁″=\sqrt{L₁″²+L₃″²−2L₁″L₃″ cos(θ₁″−θ₂″)};

wherein, L₁″ is a distance between the sender 910 and the primary BTS 904, and L₃″ is a distance between the subscriber 920 and the primary BTS 904; θ₁″ is an angle between the sender 910 and the subscriber 920 relative to the primary BTS 904, and θ₂″ is an angle between the subscriber 920 and the reference BTS 906 relative to the primary BTS 904.

According to the above description, when calculating the distances between the senders and the subscribers, the mobile communication systems choose a BTS to be the primary BTS, applies the Law of Cosines on a triangle defined by the primary BTS, the sender, and the subscriber, thus calculating the distances between the senders and the subscribers.

However, the calculation of the distances between the mobile phones differs, depending on the cell systems the mobile phones are located. If the two mobile phones are located in a common cell system, or the mobile phones are located in two adjacent cell systems respectively having at least two shared BTSs (such as the BTSs 304 and 306 in FIG. 1, the BTSs 904 and 903 in FIG. 3), the mobile communication system chooses one of the shared BTSs as the primary BTSs (such as the BTS 304 in FIG. 1, the BTS 904 in FIG. 3), and chooses another shared BTS as the reference BTSs (such as the BTS 306 in FIG. 1, the BTS 906 in FIG. 3). The distances between the mobile phones can be calculated according to the positions of the mobile phones, the primary BTSs, and the reference BTSs. If the mobile phones are located in different cell systems, and the cell systems are not adjacent to each other, the cell systems do not have at least two shared BTSs, one of the BTSs is chosen as the primary BTS (such as the BTS 402 in FIG. 2), one of the BTSs surrounding one cell system is chosen as the first reference BTS (such as the BTS 406 in FIG. 2), one of the BTSs surrounding the other cell system is chosen as the second reference BTS (such as the BTS 408 in FIG. 2). The distance between the mobile phones can also be calculated according to the position of the mobile phone, the primary BTS, and the reference BTS.

A working principle for calculating the distance between the mobile phones will be described, taking the mobile communication system 400 in FIG. 2 as an example. When the sender 420 sends out a get distance request for measuring the distance between the sender 420 and the subscriber 430, a first base station controller (BSC) connecting with the BTSs defining the cell system that the sender 420 is located receives the get distance request, and forwards the get distance request to a mobile switching center (MSC). The MSC sends the get distance request to the subscriber 430 through a second BSC and BTSs connecting to the BSC on the subscriber side.

The subscriber 430 provides a response to the get distance request. The response is transmitted to the MSC through the BTSs and the BSC on the subscriber side. If the response indicates that the get distance request is permitted, the MSC calculates to determine the position of the sender 420 and the subscriber 430. Further, the MSC calculates the distance between the two mobile phones according to the positions of the mobile phones, and sends calculated distance to the sender 420 through the BSC and the BTSs on the sender side. Thereby, a mobile communication service for measuring the distance between the mobile phones is accomplished. If the response of the subscriber 430 indicates that the get distance request is not permitted, the MSC sends a rejection message to the sender 420 through the BSC and the BTSs on the sender side.

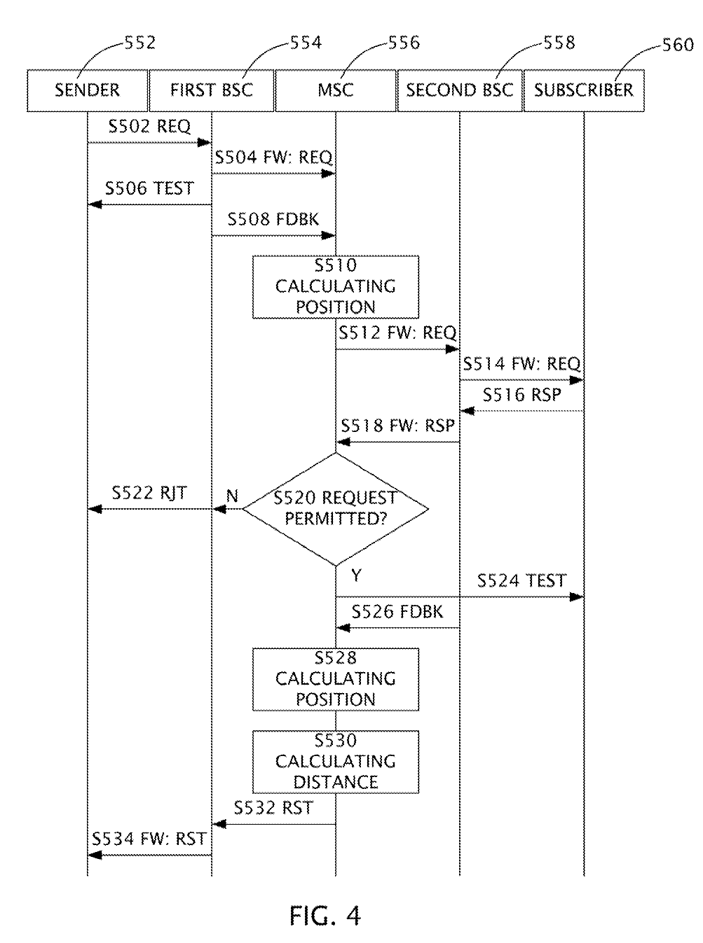

Referring to FIG. 4, a workflow of the mobile communication system according to an exemplary embodiment is illustrated.

In step S502, a sender 552 sends out a get distance request to a first BSC 554 which on the sender side.

In step S504, the first BSC 554 forwards the get distance request to a MSC 556.

In step S506, the MSC 556 informs the first BSC 554 to send a first test signal to the sender 552.

Step S508, the sender 552 sends out a first feedback signal in response to the first test signal. The first feedback signal is then transmitted to the MSC 556.

Step S510, the MSC 556 calculates a position of the sender 552 according to the first feedback signal.

Steps S512 and S514, the MSC 556 sends the get distance request to a subscriber 560 through a second BSC 558 and BTSs on the subscriber side.

Step S516, the subscriber 560 gives a response to the get distance request. The second BSC 558 receives the response.

Step S518, the second BSC 558 forwards the response to the MSC 556.

Step S520, the MSC 556 determines, according to the response, whether the get distance request is permitted.

Step S522, if it is concluded in the step S520 that the get distance request is not permitted, the MSC 556 sends a rejection message to the sender 552 through the BSC 554 on the sender side.

Step S524, if it is concluded in the step S520 that the get distance request is permitted, the MSC informs the second BSC 558 on the subscriber side to send a second test signal to the subscriber 560.

Step S526, the subscriber 560 sends out a second feedback signal in response to the second test signal. The second feedback signal is transmitted to the MSC 556.

Step S528, the MSC 556 calculates a position of the subscriber 560 according to the second feedback signal from the subscriber 560.

Step S530, the MSC 556 calculates the distance between the sender 552 and the subscriber 560 according to the positions of the two mobile phones, and generates a calculation result.

Steps S532 and S534, the calculation result is sent to the sender 552 through the BSC 554 on the sender side.

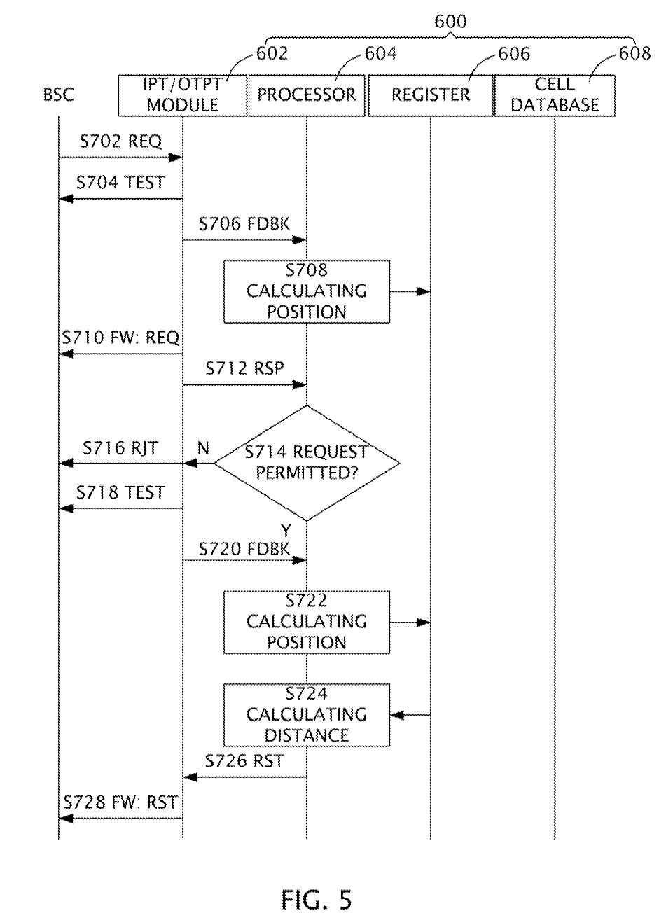

Referring to FIG. 5, a block diagram of a mobile switching center and a workflow of the calculation is illustrated. A mobile switching center (MSC) 600, according to an exemplary embodiment, includes an input/output module 602, a processor 604, a register 606, and a cell database 608.

The input/output module 602 is used for receiving a get distance request and a feedback to a test signal from the sender side, and forwarding the get distance request to the BSC on the subscriber side. The input/output module 602 is also used for receiving a response to the get distance request and the feedback to the test signal from the subscriber side.

The processor 604 is used for calculating positions of the sender and the subscriber, and calculating the distance between the sender and the subscriber according to the positions of the sender and the subscriber.

The register 606 is used for registering the positions of the sender and the subscriber, and other necessary interior data that is generated during calculation procedures of the processor 604.

The cell database 608 stores information about cell systems in which the mobile phones are located. When the mobile phones are taken from a previous cell system to a next one, the cell database 608 updates the information about the cell systems.

The calculation workflow of the processor 600 according to an exemplary embodiment is described below.

In step S702, the input/output module 602 receives a get distance request transmitted from a base station controller (BSC) on the sender side.

In step S704, the input/output module 602 sends a test signal to the BSC on the sender side. The test signal is sent to the sender through the BSC on the sender side.

Step S706, the input/output module 602 receives a feedback signal from the sender, and forwards the feedback signal to the processor 604.

Step S708, the processor 604 calculates the position of the sender according to the feedback signal, and registers the position of the sender in the register 606.

Step S710, the input/output module 602 forwards the get distance request to the BSC on the subscriber side, the get distance request is sent to the subscriber through the BSC on the subscriber side.

Step S712, after the subscriber having made a response to the get distance request, the input/output module 602 receives the response through the BSC on the subscriber side. The response is transmitted to the processor 604.

Step S714, the processor 604 determines, according to the response, whether the get distance request is permitted by the subscriber.

Step S716, if it is concluded in step S714 that the get distance request is not permitted, the input/output module 702 sends a rejection message to the BSC on the sender side.

Step S718, if it is concluded in step S714 that the get distance request is permitted by the subscriber, the input/output module 602 sends a test signal to the BSC on the subscriber side. The test signal is further transmitted to the subscriber through a BSC on the subscriber side.

Step S720, the input/output module 602 receives a feedback signal to the test signal from the subscriber. The feedback signal is forwarded to the processor 604.

Step S722, the processor 604 calculates the position of the subscriber according to the feedback signal sent by the subscriber. The position of the subscriber is registered in the register 606.

Step S724, the processor 604 reads the positions of the sender and the subscriber from the register 606, and calculates the distance between the sender and the subscriber according to their positions. The processor 604 generates a calculation result.

Steps S726 and S728, the processor 604 sends the calculation result to the input/output module 602. The input/output module 602 forwards the calculation result to the BSC on the sender side, and further the calculation result is sent to the sender through the BSC on the sender side. Therefore, a measure service is accomplished.

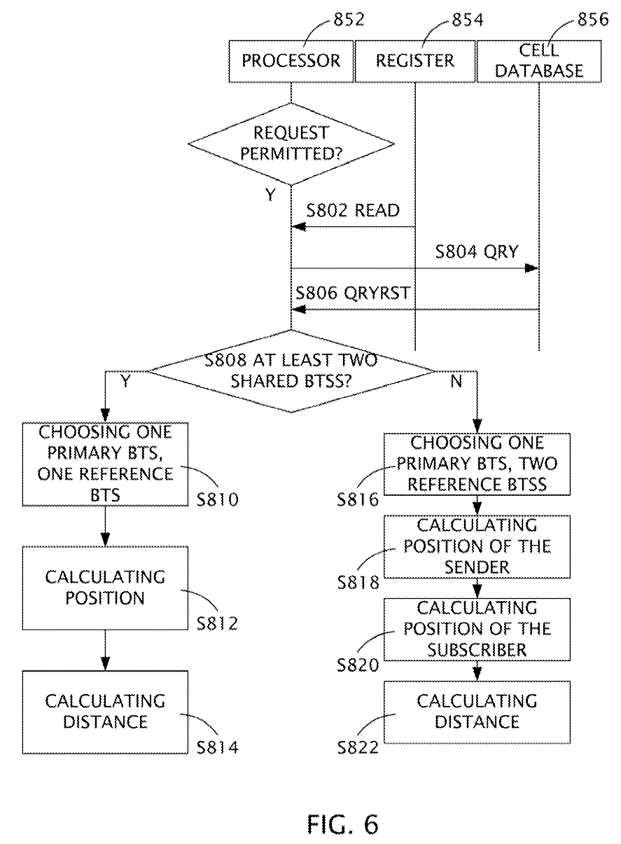

Referring to FIG. 6, a workflow of the calculation for the distance between the sender and the subscriber according to an exemplary embodiment is illustrated. In this embodiment, when a get distance request is transmitted to a processor 852, test signals are sent to both the sender and the subscriber. The processor 852 calculates positions of the sender and the subscriber, and registers the positions of the sender and subscriber in a register 854.

Step S802, if it is determined by the processor 852 that the get distance request is permitted by the subscriber, the processor 852 reads the positions of both the sender and the subscriber from the register 854.

Step S804, the processor 852 sends a query command to a cell database 856, for determining which cell systems that the sender and the subscriber are located.

Step S806, the cell database 856 gives a query result to the processor 852 according to the query command. The query result includes information about the cell systems in which the sender and the subscriber are located.

Step S808, the processor 852 determines, according to the query result, whether the cell systems in which the mobile phones are located have at least two shared BTSs. If at least two shared BTSs are included, the procedure goes to step S810, otherwise the procedure goes to step S816.

Step S810, if it is concluded in the step S808 that the cell systems that the two mobile phones are located have two shared BTSs, one of the shared BTSs is chosen as a primary BTS (such as the BTS 304 in FIG. 1), and another one of the shared BTSs is chosen as a reference BTS (such as the BTS 306 in FIG. 1).

Step S812, the processor 852 calculates positions of the two mobile phones with respect to the primary BTS and the reference BTS.

Step S814, the processor 852 calculates a distance between the sender and the subscriber according to the positions of the mobile phones. The distance between the two mobile phones can be calculated by:

X₁=\sqrt{L₁²+L₃²−2L₁L₃ cos(θ₁+θ₂)},

as shown in FIG. 1, or

X₁″=\sqrt{L₁″²+L₃″²−2L₁″L₃″ cos(θ₁″−θ₂″)},

as shown in FIG. 3.

Choice between the two equations above depends on whether the two mobile phones are located in a common cell system, which further depends on the location of the mobile phones. And thus, a measure service is accomplished.

Step S816, if it is concluded in the step S808 that the cell systems that the two mobile phones are located do not have two shared BTSs, one of the BTSs surrounding either one of the cell systems is chosen as the primary BTS, another of the BTSs surrounding one of the cell systems is chosen as a first reference BTS, and one of the BTSs surrounding the other cell system is chosen as the second reference BTS.

Step S818, the processor 852 calculates the position of the sender, including a distance (such as L₁′) between the sender and the primary BTS, and an angle (such as θ₁′) between the sender and the first reference BTS relative to the primary BTS.

Step S820, the processor 852 calculates the position of the subscriber, including a distance (such as L₃′) between the subscriber and the primary BTS, and an angle (such as θ₅) between the subscriber and the second reference BTS relative to the primary BTS.

Step S822, the processor 852 calculates the distance (such as X₁′) between the sender and the subscriber, by, for example:

X₁′=\sqrt{L₁′²+L₃′²−2L₁′L₃′ cos(θ₁′+θ₄+θ₅)};

wherein
θ₄ is an angle between the first reference BTS and the second reference BTS relative to the primary BTS.
   Therefore, a measure service is accomplished.

The mobile communication system and method calculates the position of the sender and the subscriber. After the get distance request is permitted by the subscriber, the distance between the sender and the subscriber is calculated and sent to the sender. This meets the demands for measuring the distance between mobile phones. Further, the mobile communication system and method accomplishes the measurement all in the core network devices without changing present network, which performance is also rather stable.

What is claimed is:

1. A mobile communication system comprising:
at least one base transceiver station for exchanging data with mobile phones;
a mobile switching center for choosing one base transceiver station as a primary base transceiver station, and calculating positions of the mobile phones;
wherein the position of the mobile phones including distances that the mobile phones are away from the primary base transceiver station, and an angle between the mobile phones relative to the primary base transceiver station; the mobile switching center is configured for calculating a distance between the first and second mobile phone according to the positions of the mobile phones.

2. The mobile communication system as claimed in claim 1, wherein the mobile switching center comprising:
an input/output module for sending/receiving data to/from the mobile phones;
a processor for calculating the position of the mobile phones, and the distance between the mobile phones.

3. The mobile communication system as claimed in claim 2, wherein the mobile switching center further comprising a cell database for storing information about cell systems that the mobile phones are located, the processor is used for sending a query command to the cell database, for determining the cell systems that the mobile phones are located.

4. The mobile communication system as claimed in claim 3, wherein the processor is configured for determining whether the cell systems that the mobile phones are locates have shared base transceiver stations according to a query result that the cell database gives in response to the query command.

5. The mobile communication system as claimed in claim 4, wherein the processor is configured for choosing one of the shared base transceiver stations as the primary base transceiver station if the cell systems that the mobile phones are located have at least two shared base transceiver stations.

6. The mobile communication system as claimed in claim 5, wherein the processor is configured for choosing another one of the shared base transceiver stations as a reference base transceiver station if the cell systems that the mobile phones are located have at least two shared base transceiver stations; and calculating a first angle between the first mobile phone and the reference base transceiver station relative to the primary base transceiver station, a second angle between the second mobile phone and the reference base transceiver station relative to the primary base transceiver station, a first distance that the first mobile phone is away from the primary base transceiver station, and a second distance that the second mobile phone is away the primary base transceiver station.

7. The mobile communication system as claimed in claim 6, wherein the distance between the mobile phones is calculated by:
X₁=\sqrt{L₁²+L₃²−2L₁L₃ cos(θ₁+θ₂)};
wherein
X₁ refers to the distance between the mobile phones;
L₁ refers to the first distance between the first mobile phone and the primary base transceiver station;
L₃ refers to the second distance between the second mobile phone and the primary base transceiver station;
θ₁ refers to the first angle between the first mobile phone and the reference base transceiver station relative to the primary base transceiver station; and
θ₂ refers to the second angle between the second mobile phone and the reference base transceiver station relative to the primary base transceiver station.

8. The mobile communication system as claimed in claim 6, wherein the distance between the mobile phones is calculated by:
X₁″=\sqrt{L₁″²+L₃″²−2L₁″L₃″ cos(θ₁″−θ₂″)},
wherein
X₁″ refers to the distance between the mobile phones;
L₁″ refers to the first distance between the first mobile phone and the primary base transceiver station;
L₃″ refers to the second distance between the second mobile phone and the primary base transceiver station;
θ₁″ refers to the first angle between the first mobile phone and the reference base transceiver station relative to the primary base transceiver station; and
θ₂″ refers to the second angle between the second mobile phone and the reference base transceiver station relative to the primary base transceiver station.

9. The mobile communication system as claimed in claim 5, wherein if the cell systems that the mobile phones are located do not have at least two shared base transceiver stations, the processor chooses one of the base transceiver stations surrounding one cell system as a first reference base transceiver station, and one of the base transceiver stations surrounding another cell system as a second reference base transceiver station; the processor is configured for calculating a first distance that the first mobile phone is away from the primary base transceiver station, a second distance that the second mobile phone is away from the primary base transceiver station, a first angle between the first mobile phone and the first reference base transceiver station relative to the primary base transceiver station, a second angle between the first and the second reference base transceiver station relative to the primary base transceiver station, and a third angle between the second mobile phone and the second reference base transceiver station relative to the primary base transceiver station.

10. The mobile communication system as claimed in claim 9, wherein the distance between the mobile phones is calculated by:
X₁′=\sqrt{L₁′²+L₃′²−2L₁′L₃′ cos(θ₁′+θ₄+θ₅)},
wherein
X₁′ refers to the distance between the mobile phones;
L₁′ refers to the first distance between the first mobile phone and the primary base transceiver station;
L₃′ refers to the second distance between the second mobile phone and the primary base transceiver station;
θ₁′ refers to the first angle between the first mobile phone and the first reference base transceiver station relative to the primary base transceiver station;
θ₄ refers to the second angle between the first and the second reference base transceiver station relative to the primary base transceiver station; and
θ₅ refers to the third angle between the second mobile phone and the second reference base transceiver station relative to the primary base transceiver station.

11. The mobile communication system as claimed in claim 1, wherein the mobile switching center comprising:
an input/output module for receiving a get distance request from a first mobile phone, and transmitting the get distance request to a second mobile phone that the get distance request aims at; the input/output module further configured for receiving a response from the second mobile phone;
a processor for determining whether the get distance request is permitted by the second mobile phone according to the response transmitted from the input/output module, and calculating the distance between the mobile phones according to the positions of the mobile phones if the response indicates that the get distance request is permitted.

12. A mobile communication method, comprising:
choosing a base transceiver station as a primary base transceiver station;
calculating a first position of a first mobile phone, including a first distance that the first mobile phone is away from the primary base transceiver station;
calculating a second position of a second mobile phone, including a second distance that the second mobile phone is away from the primary base transceiver station; and
calculating a distance between the first and the second mobile phone according to the first position of the first mobile phone and the second position of the second mobile phone.

13. The mobile communication method as claimed in claim 12, further comprising: calculating an angle between the first and the second mobile phones relative to the primary base transceiver station.

14. The mobile communication method as claimed in claim 12, further comprising steps of:
determining cell systems that the mobile phones are located;
determining whether the cell systems that the mobile phones are located have shared base transceiver stations;
choosing one of the shared base transceiver stations as the primary station if the cell systems have shared base transceiver stations.

15. The mobile communication method as claimed in claim 14, further comprising step of:
choosing another one of the shared base transceiver stations as a reference base transceiver station;
calculating a first angle between the first mobile phone and the reference base transceiver station relative to the primary base transceiver station; and
calculating a second angle between the second mobile phone and the reference base transceiver station relative to the primary base transceiver station.

16. The mobile communication method as claimed in claim 15, further comprising: calculating the distance between the first and the second mobile phones by:
X₁=\sqrt{L₁²+L₃²−2L₁L₃ cos(θ₁+θ₂)};
wherein
X₁ refers to the distance between the mobile phones;
L₁ refers to the first distance between the first mobile phone and the primary base transceiver station;
L₃ refers to the second distance between the second mobile phone and the primary base transceiver station;
θ₁ refers to the first angle between the first mobile phone and the reference base transceiver station relative to the primary base transceiver station; and
θ₂ refers to the second angle between the second mobile phone and the reference base transceiver station relative to the primary base transceiver station.

17. The mobile communication method as claimed in claim 15, further comprising: calculating the distance between the first and the second mobile phones by:
X₁″=\sqrt{L₁″²+L₃″²−2L₁″L₃″ cos(θ₁″−θ₂″)},
wherein
X₁″ refers to the distance between the mobile phones;
L₁″ refers to the first distance between the first mobile phone and the primary base transceiver station;
L₃″ refers to the second distance between the second mobile phone and the primary base transceiver station;
θ₁″ refers to the first angle between the first mobile phone and the reference base transceiver station relative to the primary base transceiver station; and
₂θ refers to the second angle between the second mobile phone and the reference base transceiver station relative to the primary base transceiver station.

18. The mobile communication method as claimed in claim 14, further comprising step of:
choosing one of the base transceiver stations as the primary station if the cell systems do not have shared base transceiver stations
choosing one of the base transceiver stations surrounding one cell system as a first reference base transceiver station;
choosing one of the base transceiver stations surrounding another cell system as a second reference base transceiver station;
calculating a first distance that the first mobile phone is away from the primary base transceiver station;
calculating a second distance that the second mobile phone is away from the primary base transceiver station;
calculating a first angle between the first mobile phone and the first reference base transceiver station relative to the primary base transceiver station;
calculating a second angle between the first and the second reference base transceiver station relative to the primary base transceiver station; and
calculating a third angle between the second mobile phone and the second reference base transceiver station relative to the primary base transceiver station.

19. The mobile communication method as claimed in claim 18, further comprising:
calculating the distance between the first and the second mobile phones by:
X₁′=\sqrt{L₁′²+L₃′²−2L₁′L₃′ cos(θ₁′+θ₄+θ₅)},
wherein
X₁′ refers to the distance between the mobile phones;
L₁′ refers to the first distance between the first mobile phone and the primary base transceiver station;
L₃′ refers to the second distance between the second mobile phone and the primary base transceiver station;
θ₁′ refers to the first angle between the first mobile phone and the first reference base transceiver station relative to the primary base transceiver station;
θ₄ refers to the second angle between the first and the second reference base transceiver station relative to the primary base transceiver station; and
θ₅ refers to the third angle between the second mobile phone and the second reference base transceiver station relative to the primary base transceiver station.

20. The mobile communication method as claimed in claim 12, further comprising steps of:
forwarding a get distance request that is sent from the first mobile phone to the second mobile phone;
receiving from the second mobile phone a response to the get distance request;
determining whether the response indicates that the get distance request is permitted; and
choosing a base transceiver station as the primary base transceiver station if the response indicates that the get distance request is permitted.
